(19) United States
(12) Patent Application Publication
(10) Pub. No.: US 2022/0022453 A1
(43) Pub. Date: Jan. 27, 2022

(54) COMPOSITIONS AND TREATMENTS FOR MICROBIAL PERSISTER CELLS

(71) Applicant: Lanny Leo Johnson, Frankfort, MI (US)

(72) Inventor: Lanny Leo Johnson, Frankfort, MI (US)

(21) Appl. No.: 17/470,436

(22) Filed: Sep. 9, 2021

Related U.S. Application Data
(63) Continuation-in-part of application No. 16/947,256, filed on Jul. 24, 2020.

(51) Int. Cl. A01N 37/40; A01N 25/22

(52) U.S. Cl. CPC A01N 37/40; A01N 25/22

(57) ABSTRACT

This disclosure is directed to methods and compositions including protocatechuic acid for destroying, inactivating, and/or inhibiting a persister cell including contacting a persister cell with a composition comprising protocatechuic acid crystals. The composition may include a liquid vehicle, and a stabilizer. The stabilizer may be an oil including an essential oil. The liquid vehicle may include an alcohol including isopropyl alcohol and/or ethanol.

### CROSS REFERENCE TO RELATED APPLICATIONS

This application is a continuation in part of U.S. application Ser. No. 16/947,256 filed Jul. 24, 2020, which is herein incorporated by reference in its entirety.

### BACKGROUND OF THE DISCLOSURE

### Field of the Invention

The present invention relates to methods and compositions for destroying, inactivating, and/or inhibiting a microbial persister cell including contacting a persister cell with a composition comprising protocatechuic acid crystals.

### Description of the Related Art

Microbial persister cells with inherent tolerance to antimicrobials were first described in the 1940's. Persister cells are subpopulations of cells that resist treatment and become antimicrobial tolerant by changing to a state of dormancy or quiescence for a period of time. Persister cells in their dormancy do not divide. It is important to recognize the tolerance shown in persister cells differs from antimicrobial resistance in that the tolerance is not inherited and is reversible. When treatment has stopped the state of dormancy can reverse and the cells can reactivate and multiply. Many persister cells are bacterial, and there are also viral persister cells, fungal persister cells, yeast persister cells, and cancer persister cells that show tolerance for cancer drugs.

As one application example, infections in joint surgery are reported to be low but the 5-year mortality is more than 20 percent. In terms of 5-year survival, this is similar to cancer treatment statistics. Persister bacteria are thus significant, well published in the literature, yet generally unrecognized, silent killers in surgical site infections.

Microbial persister cells are cells which possess distinct characteristics from other counterparts. Persister cells are identified with a wide range of genera and species, including, but not limited to, Staphylococcus spp., such as S. aureus, S. epidermidis, and V. capitis; Pseudomonas spp. such as P. aeruginosa, Burkholderia spp. such as B. cepacia and B. pseudomallei; Salmonella serovars, including Salmonella typhi; Vibrio spp. such as V. cholerae; Shigella spp., Brucella spp. such as B. melitensis; Escherichia spp. such as E. coli; Lactobacillus spp. such as L. acidophilus; Serratia spp. such as S. marcescens; Neisseria spp. such as N. gonorrhoeae, as well as the unicellular fungus Candida albicans, and encoated viruses, e.g., SARS-COV2 and variants.

Persister cells are characterized by a slow-growing phenotype; that is, persister cells divide at a significantly slower rate than the rate in logarithmic bacterial growth. Some persister cells are dormant that is, the cells are not undergoing cell division. In these dormant persister cells, cellular metabolism is reduced even further than in slow-growing cells. Persister cells are significant clinically since they are often highly resistant to antimicrobials.

### SUMMARY OF THE INVENTION

This disclosure is directed to methods and compositions including protocatechuic acid for destroying, inactivating, and/or inhibiting a microbial persister cell including contacting a persister cell with a composition comprising protocatechuic acid crystals. The composition may include a liquid vehicle, and a stabilizer. The stabilizer may be an oil including an essential oil. The liquid vehicle may include an alcohol including isopropyl alcohol and/or ethanol. The liquid may be water or propylene glycol.

This disclosure is generally directed to compositions comprising protocatechuic acid and methods of using compositions comprising protocatechuic acid (PCA) to inactivate persister cells and to prevent, interrupt, and/or treat disease and infections associated with persister cells. The compositions generally comprise protocatechuic acid in the dry state and/or in a liquid solution or environment.

PCA crystals can provide a therapeutic application by their physical nature. They have known cytotoxic properties which can achieve a therapeutic result. It is known that the physical properties of crystals can have an antimicrobial property independent or in conjunction with their biochemical properties. Their many sharp edges, for example, have the potential to physically disrupt a microbe's integrity.

Examples that closely replicate the clinical environment have demonstrated that PCA is effective in an aqueous medium. Physical disruption is one potential method of stopping the cellular invasion and clinical disease related to persister cells. Crystals have a physical structure that is irregular, rough, and sharp with potential to physically disrupt a microbes' spikes and covering. Accordingly, using crystals prevention and treatment can expand beyond, or be used in conjunction with, chemical methods that includes physical disruption. The use of crystals makes possible protecting from or destroying persister cells.

Protocatechuic acid crystals like other crystals are typically observed and considered in the dry state. However, it known that PCA retains various crystalline shapes while in a liquid medium. The PCA crystal was first reported in liquid to be in three different forms in 1949. The following publication from 1949 is extensively illustrated. See https://royalsocietypublishing.org/doi/10.1098/rspa.1949.0064. Robert Williams Wood. Published:22 Jun. 1949. https://doi.org/10.1098/rspa.1949.0064.

In 1983, Agmon et al., supported Wood's work and showed that some crystalline shapes were stable in form and other were rapidly changing in liquid. See Agmon I, Herbstein F H, Thomas J M, Spontaneous deformation of protocatechuic acid monohydrate crystals: crystallographic aspects, Proc. R. Soc. Lond. 1983. A387311-330. http://doi.org/10.1098/rspa.1983.0062.

Based upon these findings there is application for interruption of transmission in many ways. There is the application for sanitizing human skin and disinfecting personal protective equipment, e.g., face masks, and implants. Spraying the alcoholic dual reagents on hard surfaces kills what is present and leaves a PCA residue coating to be antibacterial and virucidal. This interrupts the transmission from hard surfaces to hands to the subject's face. In addition, fogging and or aerophization of trains, planes, and automobiles may be accomplished. These methods of interruption may be used in buildings and or arenas. It may be applied to room filters. When water is the vehicle there is an initial dilution of the microbes followed by drying leaving an enduring antimicrobial crystalline matrix of the surface of the article. Accordingly, the process leaves a PCA residue and/or coating which has an enduring presence into the time and space that persister pathogens reemerge.

The present clinical significance of these observations is that PCA in fluid would retain its various crystalline shapes and therefore its anti-viral properties lend PCA to a treatment modality. This would be expected in an aerosol and body fluids. The application is available for oral, intravenous, and intraperitoneal routes. It may be used in a nebulizer or ventilator.

PCA is FDA designated as safe with a Generally Recognized As Safe (GRAS) for food substance flavoring. PCA is safe to ingest and therefore ready for translation to clinical application. Its ready availability and low cost of goods insures a wide societal distribution.

A virus or persister cell including those in a biofilm state are physically disrupted when it comes in physical contact with protocatechuic acid crystals and therefore renders the virus or persister pathologically inactivated. PCA and related methods can be deployed to interrupt transmission in several ways. PCA crystals can be applied topically and/or delivered in a liquid vehicle. Alcohol provides a dual effect when it is the vehicle for use as a sanitizer and or disinfectant on skin or hard surfaces. The alcohol kills what is present and after drying the residual surface PCA coating provides a continuing anti-viral and/or anti-bacterial function. It may be applied to hard surfaces to protect from this mode of transmission. It may be used as a coating and on application transmission is interrupted by PCA; in one embodiment it may be in a liquid vehicle, and a stabilizer.

In embodiments, the liquid vehicle comprises an alcohol and the stabilizer comprises an oil. In preferred embodiments, the oil is an essential oil. In embodiments, the compositions may comprise principally protocatechuic acid, liquid vehicle, and stabilizer as the main ingredients. In preferred embodiments, the compositions may comprise only protocatechuic acid, a liquid vehicle, and a stabilizer.

Water is the vehicle for interruption and or treatment of the mucous membranes of the nose, mouth, pharynx, respiratory tree, and lungs. The compositions may be sprayed or fogged onto various products and articles of manufacture, and mammalian and human skin, to kill and protect from viruses, bacteria, and persister cells and viruses including encoated viruses like the Covid 19 SARS-Co-2 virus and variants.

In preferred embodiments, the liquid vehicle includes water or a low boiling point alcohol and/or alcohol combination ranging from about 0° C. to about 100° C. The alcohol may include methanol and/or butanol, but preferably ethanol and/or propanol for human use. Low boiling point alcohols can include alcohols such as methanol, ethanol, 1-propanol, 2-propanol, 1-butanol, 2-butanol, 2-methyl-1-propanol, 2-methyl-2-propanol, 1-pentanol, 3-methyl-1-butanol, 2,2-dimethyl-1-propanol, and/or cyclopentanol.

An essential oil is generally a concentrated hydrophobic liquid containing volatile (easily evaporated at normal temperatures) chemical compounds extracted from a plant. Essential oils are also known as volatile oils, ethereal oils, aethereal, or as the oil of the plant from which they were extracted. In preferred embodiments, the essential oil may comprise orange, mint, peppermint, cedarwood, lemon, southern blue gum, evergreen, clove, and/or spearmint. See Essential oil, Wikipedia, the free encyclopedia, last edited: 14 Aug. 2021, herein incorporated by reference.

Additional possible ingredients include glycerin, propylene glycol, sodium benzoate, as well as sanitizers and disinfectants. Propylene glycol may be a vehicle for topical application and or for aerophilization. See https://ajph.aphapublications.org/doi/pdf/10.2015/AJPH.34.5.477.

One embodiment of the present disclosure provides for the spraying of protocatechuic acid (PCA) in solution on a variety of articles. Upon drying the result being a coating PCA on and or in the articles substance. The preferred embodiments are an article of manufacture including personal protective equipment (PPE). Personal protective equipment includes caps, hats, and other head coverings, gowns, masks and facemasks, gloves, shoes, and other footwear, etc., condoms, and rubber gloves. The application may be at the time of manufacture and or after-market application in the clinical setting.

The products also include hard surfaces that are frequently touched or handled by the public. This would include, as nonlimiting examples, ATM machines and credit card payment devices, gas pump handles, doors and doorknobs, tables and counters in public spaces including restaurants, etc. Another such application would be the spraying or soaking of instruments with PCA solutions.

In embodiments, a single spray with dual action can kill persister bacteria and viruses including SARS-CoV-2 and variants. The first action includes an alcohol effect before evaporation. This kills the virus on contact and then dries quickly leaving a coating of PCA. The PCA coating presence on the article maintains a presence to continually kill persister cells, bacteria, and viruses upon subsequent contact. PCA in this application thus acts as a dual phase inhibitor.

In some embodiments, the alcohol will kill bacteria on contact and then the PCA coating will continue to kill and protect the surface, or article of manufacture, the subject's skin and appendages, from persister cells for a significant period of time up to at least 24 or 48 hours or in embodiments weeks, months or years.

PCA may be used in a variety of treatments. An aerosolized fog with the PCA in suspension will kill bacteria on contact. Subsequently, the PCA coating will continue to kill and protect the surface, or article of manufacture, the subject, from persister cells for a significant period up to at least 24 hours, or days, weeks, months or years.

In preferred oral ingestion embodiments, the ready absorption places the PCA crystal in solution in the plasma which will kill persister cells on contact. This will last throughout the known presence of PCA in the mammalian body for several days. The PCA known metabolism is that it is subsequently found in urine and feces intact and as subsequent metabolites.

In the preferred embodiments of intraperitoneal route of application, the ready absorption places the PCA crystal in solution in the plasma which will kill persister cells on contact. This will last throughout the known presence of PCA in the mammalian body for several days. The PCA known metabolism is that it is subsequently found in urine and feces intact and as subsequent metabolites.

In the preferred embodiments of intravenous route of application, the presence places the PCA crystal in solution in the plasma which will kill persister cells on contact. This will last throughout the known presence of PCA in the mammalian body for several days. The PCA known metabolism is that it is subsequently found in urine and feces intact and as subsequent metabolites.

In preferred embodiments of a PCA coating application to room and respiratory filters and facilities, the PCA crystal in the ventilation system such that persister cells and bacteria are reduced or destroyed on contact.

In the preferred embodiments of the PCA coating application with a nebulizer places the PCA crystals in the subject's respiratory system such that pathologic microbes are reduced or destroyed on contact.

Also disclosed is a method of treating pathological condition caused by bacteria and persister cells, comprising the coating of skin, oral cavity, nares, nasopharynx, and pulmonary tree.

Also disclosed is methods of treatment of the pathological condition caused by bacteria and persister cells comprising the intravenous and intraperitoneal route. In embodiments, the present disclosure provides multiple routes of therapeutic delivery of PCA; e.g., coating of various products including personal protective equipment and hard surfaces. Normal size crystals (177 um) may be delivered by the oral route. Smaller sized crystals may also be used for intravenous, intraperitoneal and aerosol delivery to a patient, subject (prophylactic) or facility.

Bacteria, fungal, and related persister cells from Staphylococcus spp., such as S. aureus, S. epidermidis, and V. capitis; Pseudomonas spp. such as P. aeruginosa, Burkholderia spp. such as B. cepacia and B. pseudomallei; Salmonella serovars, including Salmonella typhi; Vibrio spp. such as V. cholerae; Shigella spp., Brucella spp. such as B. melitensis; Escherichia spp. such as E. coli; Lactobacillus spp. such as L. acidophilus; Serratia spp. such as S. marcescens; Neisseria spp. such as N. gonorrhoeae, as well as Candida albicans and candida auris are included but not limited thereto.

Other features and aspects will be apparent from the following detailed description, the drawings, and the claims.

### BRIEF DESCRIPTION OF THE DRAWINGS

FIG. 1 shows crystals of PCA upon drying on a surface.

FIG. 2 shows a representation of crystals of PCA in a water droplet.

FIG. 3 shows a representation of crystals of PCA dissolved in ethanol.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, products, and/or systems, described herein. However, various changes, modifications, and equivalents of the methods, products, and/or systems described herein will be apparent to an ordinary skilled artisan.

Protocatechuic acid (PCA) is a phytochemical, a powerful antioxidant, which is common in nature. See Protocatechuic acid, Wikipedia, the free encyclopedia, last edited 7 Jun. 2021, herein incorporated by reference. It is found in abundance in plants, tree leaves, and edible fruits and vegetables. PCA is naturally present in the ground, rivers, ponds, and lakes. It is manufactured by bacteria in the soil. It is present in the human diet. The metabolism in nature and the human body is known. After ingestion, injection or a topical application, the tissue and organs of residence are known. The human bowel bacteria manufacture PCA. The routes of elimination are known. There are no known human toxic effects of PCA. PCA is non-allergenic and a non-inflammatory. It is also non-mutagenic. PCA's health benefits are established in the literature. Importantly for a new therapeutic, protocatechuic acid (PCA) has been designated as Generally Recognized As Safe (GRAS) by the FDA as a flavoring substance. PCA may be biochemically manufactured and/or extracted from plants in an amorphous or crystalline state. Both states have the antibacterial, anti-viral properties of low pH, anti-protease, docking blocker and hormonal and cellular immunity remains inherent in the molecule.

As mentioned, protocatechuic acid (PCA) is a compound with powerful anti-inflammatory properties. One of the ways the human body responds to PCA is with a massive anti-inflammatory response. The pathological effect seen in clinical cases of SARS Co-2 has been termed a ‘cytokine storm’ in the lungs. PCA is a powerful anti-inflammatory by its anti-catabolic cytokine blocker properties. PCA acts as a tyrosinase inhibitor in other applications. PCA is also a protease inhibitor. PCA has anti-viral docking properties. Protocatechuic acid (PCA) is thus a broad-spectrum antiviral and antibacterial destroying antibiotic when coating of cloth and/or metal surfaces.

PCA has the physical properties of a crystal with sharp protrusions that disrupt the coating of microbes in the dry state or in solution. Protocatechuic acid (PCA) crystals have viricidal effects on encoated virus like the SARS CoV2 virus. The interruption of transmission and/or treatment can be in an aqueous environment. The interruption of transmission can be designed to engage the persister cells and/or coronavirus in such an environment; i.e., aerophilized droplets. The successful treatment will be likewise; within the confines of the mammalian body's nasopharynx, bronchi, lungs and vascular system.

The crystal structure of PCA may cause physical disruption of viral coating resulting in viral death. PCA in the blood will retain its crystalline and therefore its anti-viral properties. The crystalline physical nature may be constantly changing in solution. PCA in a liquid (water and possibly alcohol or other vehicles) retains various crystalline forms of varying shapes, but with sharp edges. This crystalline antiviral, antibacterial, factor of PCA is thus present whether in a liquid vehicle or dried on a hard surface.

Mutations of a COVID-19 virus would require a generally differing therapeutic, biochemical, or chemical approach. PCA inherent structure may involve physical disruption of the COVID-19 virus and low pH and so it would be expected to work against any mutations.

In embodiments, the size of PCA crystals may be approximately 177 microns. Subject to size reduction the size will differ by the method used and the source of the product. A smaller physical crystal size is also possible. Smaller crystal sizes may be more soluble.

In addition, PCA crystals can be subject to physical grinding or jet spraying to make into a powder. The smaller size is less than that of a human red blood cell. The rbc has a disk diameter of approximately 6.2-8.2 μm and a thickness at the thickest point of 2-2.5 μm and a minimum thickness in the center of 0.8-1 μm. This post ground size is much smaller than most human cells.

Co-crystals of PCA is another means to coat skin or hard surfaces. The solubility of PCA in water is approximately 10 mg/ml and LD50 is 800 mg/kg which makes PCA a potential co-crystal former. Seven novel cocrystals of PCA with ε-Caprolactam, Isonicotinamide, Isonicotinic acid (hydrated and anhydrate cocrystals), Theophylline, Nicotinamide and Carbamazepine are known.

In embodiments, crystals of PCA can thus be placed in a liquid vehicle for delivery to a target, for example, skin or personal protective coating. Accordingly, in embodiments, the present disclosure provides coating of various products including personal protective equipment and hard surfaces. Smaller sized crystals may also be used for intravenous and aerosol delivery to a patient.

Oral and Nasal applications of PCA crystals may use water as a vehicle and, in embodiments, at a maximal concentration of about 1.24% PCA. The vehicle may be sterile water and or saline solution with a minimal amount of an essential oil or other for stability. PCA may be combined with a cellulose vehicle in nasal topical application. As mentioned, safety is inherent as PCA is FDA approved as a food flavoring additive as are the essential oils. Therefore, any entry into or beyond the oral cavity is inherently safe.

In embodiments, personal protective equipment may be coated or infused with PCA crystals. Coatings may be applied at the time of manufacture or after-market, i.e., while in use. In embodiments, an alcohol-based solution with 1 to 30% PCA may be used depending upon the intended application. The typical amount might be about 3% in a spray container, apparatus, and/or mechanized delivery at manufacture of the article as with robotics and or assembly line.

In this embodiment, the alcohol vehicle causes an immediate 99% plus viral kill when wet. Upon drying, PCA crystals remain as an anti-viral coating. PCA in this form on metal and or cloth destroys persister cells on contact. The function can be based upon the PCA crystals in solution, and or dry. Solutions as low as 0.125% may be use on retails articles that are handled by the public for trying on; i.e. seeing, sun or protective glasses.

In embodiments, benefits for protective masks is clear since studies have shown masks to harbor bacteria and virus for up to 6 days. Face masks have limitations for two reasons. They were made for controlling dust particles and not liquid droplets. In addition, there must be passage of air in and out for breathing. The N95 mask is promoted as the best alternative. However, those with a valve will allow particles to escape. Thereby they may protect the wearer, but if the wearer is contagious there is no protection for others. The 3M mask known as the 8511 Respirator with a Cool Flow Valve made by 3M is made for construction workers to control dust and allow for easy breathing.

It is noted that each particulate respirator is given a filter efficiency rating of 95, 99, or 100 when tested against particles that are the most difficult size to filter—approximately 0.3 microns in size mass median aerodynamic diameter (MMAD). NIOSH class 95 particulate respirator filters are certified to be at least 95% efficient. It is noted that 100% is not possible.

The present disclosure thus provides important additional protection for filtering. This is accomplished with a coating on the filter so that any bacteria passing through will be destroyed, and much more so than if no coating of PCA is present.

The disclosure further provides for spraying or wiping of surfaces including hard surfaces with PCA in an alcohol vehicle which results in immediate persister cell removal. In addition, the crystal coating on hard surfaces like handles, doorknobs, gas pumps will then remain and continue to be effective for a significant period afterwards.

The supporting experimental tests described below replicate a clinical application in several ways. First, is the effectiveness of the deposit of dry crystals on hard surfaces; metal and plastic. Then the application to apply dry crystals to N95 outer mask material. Unique to the testing methods was that the virus was delivered in a liquid medium; alcohol, propylene glycol, essential oil and/or water. Therefore, the tests on virus assessed the effect of crystals of PCA in a solution to inactivate the virus in a liquid medium. This replicates the clinical transmission of the SARS Co-2 virus which is aerophilized droplets means of spreading in a liquid medium, and the virus is inactivated by the PCA crystals in solution.

The present invention provides methods, compositions and uses for treating surfaces (solid, smooth, porous or semi-porous, or cloth-like) and liquids to reduce persister cells or to sanitize or sterilize a surface. More specifically, the methods and compositions described herein include contacting any surface with a composition comprising PCA thereby reducing or preventing persister cells on said surface, or to sanitize or sterilize the surface. The surfaces can be in the health care setting, sports setting, including stadiums, or food preparation settings or any setting where sterile surfaces are needed.

The compositions can be applied to solid surfaces such as implants, or solid surfaces like operating tables, benches, equipment, patient beds, etc. or surgical instruments to sanitize or sterilize the surface. Solid surfaces such as operating tables, other equipment and other surfaces can be treated as well by spraying of the surface with compositions comprising PCA.

In addition, the compositions can be applied to smooth, porous, or semi-porous, or cloth-like surfaces such as wound dressings, bedding, vascular implants, bandages, etc. The material can be treated with the PCA solution and then used immediately, or the material can be allowed to dry and then used. For example, a bandage can be treated with PCA and then allowed to dry and store (for about up to 2 years known shelf life). When needed, depending upon the nature of the wound, the bandage can either be applied directly to the wound or can be wetted with water, 70-90% isopropyl alcohol, saline, or propylene glycol and/or essential oils and then applied to the wound. It is preferred to use propylene glycol and an essential oil as they enhance the absorption of PCA into the skin.

When the composition of this invention is applied to as an element of a covering or bandage, to adhere to a surface to be treated, such as a wound, the composition generally can include a concentration of the PCA of at least 1.24% to 30% by weight of the compound depending upon the chemical nature of the vehicle and the target. In certain embodiments a 25 mM concentration of PCA is applied to a bandage. Further, the compounds of this invention will be between 20-30% by weight of the compound for one intended use and more preferably, between 1.24% and 30% by weight of the compound depending upon the chemical nature of the vehicle, the target being treated and the species of virus to be treated.

Further, the methods and compositions described herein include adding the composition comprising PCA thereof to liquid or fluid, including other sanitizing solutions and/or sanitizing components. Further still, the methods and compositions described herein include adding the composition comprising PCA to any other vehicle, including but not limited to a powder, paste, cream foam, gel, wipes, other sanitizing components and the like thereby killing, reducing or preventing persister cells on said surface.

The present invention provides a composition that destroys persister cells. The composition includes PCA. The PCA may be mixed with 70% isopropyl alcohol and or small amount of essential oil, e.g., lemon, peppermint, etc. The concentration of PCA can be anywhere from about 20% by weight PCA to 100% PCA. Preferably the concentration of PCA varies with the intended purpose from 1.24%, 20%, 30%, 20-50% or 20-40% or 20-30% by weight. When the PCA is used in a crystal form, then the crystals can be up to 100% PCA by weight.

The PCA may be in the form of crystals that are embedded into a material such as a cloth or a mesh, such as titanium or stainless steel. The crystals may be applied to a surface configuration that provides for housing of the crystal on the surface. The same is for cloth material that has mesh or surface to house the physical crystals by size. They may remain in place in crystal form until activated, for example, when subject to fluid common to the mammalian body.

The amount of PCA necessary for coating metal and or cloth may be 20 to 30% PCA or 20-30 grams per 100 ml of 70% isopropyl alcohol. These compositions allow for higher concentrations and evaporate rapidly to dry state of PCA crystals on the surface or cloth. In another aspect of the present invention, a method of disinfecting a surface comprising contacting said surface with PCA is contemplated.

This disclosure provides for a method comprising contacting a surface with an effective amount of the composition. By the term “effective amount” of a composition as provided herein is meant an amount of a composition sufficient to provide the desired benefit. With any prescription; onset of treatment, dose, vehicle, route, interval, frequency, or duration the fundamental therapeutic action is the engagement of one or more crystals with a target in a liquid environment; in or out of the mammalian body. As disclosed herein, the exact amount required will vary from use to use depending on a variety of processing parameters, as understood by one of ordinary skill, such as the application, type of surface, the type of target to be treated, the surface size, the mode of delivery (e.g., aerosol, spraying or dipping), and the like. Determination of what constitutes an “effective amount” is made by routine testing with known concentrations and adjusting those concentrations as needed to obtain the desired benefit and can be determined by one of ordinary skill in the art using routine experimentation so that the PCA crystals engage the target.

The present invention also provides methods, compositions and uses for treating surfaces including solid, smooth, porous or semi-porous, and/or cloth-like, and liquids to reduce microbial growth or to sanitize or sterilize the surface. More specifically, the methods and compositions described herein include contacting any surface with a composition comprising PCA thereby reducing or preventing persister cells and microbial growth on the surface, or to sanitize or sterilize the surface. The surfaces can be in the health care setting, sports setting or even food preparation settings or any setting where sterile surfaces are required.

The compositions can be applied to solid surfaces such as implants, or solid surfaces like operating tables, benches, equipment, patient beds, etc. or surgical instruments to sanitize or sterilize the surface. For example, in the case of implants, the implants can be treated and coated with the compositions before inserted into the patient. Likewise, the instruments may be treated before use on a patient. Solid surfaces such as operating tables, other equipment and other surfaces can be treated as well by spraying of the surface with compositions comprising PCA.

In addition, the compositions can be applied to smooth, porous or semi-porous, or cloth-like surfaces such as wound dressings, bedding, vascular implants, bandages, etc. The material can be treated with the PCA solution and then used immediately or the material can be allowed to dry and then used. For example, a bandage can be treated with PCA and then allowed to dry and store for about up to 2 years shelf life. When needed, depending upon the nature of the wound, the bandage can either be applied directly to the wound or can be wetted with water, 70-90% isopropyl alcohol, saline, or propylene glycol and/or essential oils and then applied to the wound. It is preferred to use propylene glycol and an essential oil as they enhance the absorption of PCA into the skin.

When the antimicrobial composition of this invention is applied to an element of a covering or bandage, to adhere to a surface to be treated, such as a wound, the antimicrobial composition generally can include a concentration of PCA of at least 1.24% to 30% by weight of the compound depending upon the chemical nature of the vehicle, the target being treated and the species of bacteria to be treated. In certain embodiments a 25 mM concentration of PCA is applied to the bandage. Treatment with 25 mM PCA significantly decreases the bacterial burden of P. aeruginosa at the 48-hour interval.

Further, the methods and compositions described herein include adding the composition comprising an anthocyanin or an anthocyanidin or metabolites thereof to liquid or fluid, including other sanitizing solutions and/or sanitizing components, thereby reducing or preventing microbial growth on said surface. Further still, the methods and compositions described herein include adding the composition comprising PCA to any other vehicle, including but not limited to a powder, paste, cream foam, gel, wipes, other sanitizing components and the like thereby reducing or preventing microbial growth on said surface.

Included in the invention are compositions for, and methods of destroying, killing or significantly reducing bacterial biofilms comprising persister cells. Biofilms are comprised of bacteria that form colonies and produce a surrounding matrix film to protect themselves. The biofilm forming bacteria can form colonies that attach to foreign bodies, each other, and tissues. The bacteria aggregate in clusters and are surrounded by extracellular polymer matrix. The biofilms are hard to destroy and therefore kill the underlying bacteria and provide the basis for antibiotic resistance. Biofilms can be found attached to surfaces such as implants and catheters and they also can be embedded in the biological host, such as for example cystic fibrosis wounds. MRSA biofilms play a role in many device-related infections such as native valve endocarditis, otitis media, urinary tract infections, cystic fibrosis, acute septic arthritis, total joint implantation, catheters, pacemakers, etc. The formation of a biofilm is a two-step process: 1. Adherence of cells to a foreign body surface; and 2. Accumulation of cells to form multilayered cell clusters. A characteristic of biofilm formation in staphylococci is the production of polysaccharide intercellular adhesion.

The present invention thus provides a composition that destroys persister cells in biofilms. The composition is preferably PCA. The PCA may be mixed with 70% alcohol and or small amount of essential oil; i.e., lemon, peppermint, etc. The concentration of PCA can be anywhere from about 20% by weight PCA to 100% PCA. Preferably the concentration of PCA varies with the intended purpose from 1.24%, 20%, 30%, 20-50% or 20-40% or 20-30% by weight. The alcohol in embodiments can be isopropyl alcohol or ethanol. When the PCA is used in a crystal form, then the crystals can be up to 100% PCA by weight. The PCA may be in the form of crystals that are embedded into a material such as a cloth or a mesh, such as titanium or stainless steel. The crystals are applied to the metal where there is surface configuration that provides for housing of the crystal on the surface. The same is for cloth material that has mesh or surface to house the physical crystals by size. This may be seen in vascular grafts. They remain in place in crystal form until activated when subject to fluid common to the mammalian body. A composition comprising PCA can stop the formation of a biofilm as well as kill persister cells in biofilms.

It should be noted that the dose of PCA can vary with the application and the vehicle. The amount of PCA for instance that can be dissolved in water is 1.24 grams per 100 ml. For example, the dose of PCA that is bactericidal on Pseudomonas aeruginosa is about 0.00038 grams. When treating intact normal human skin 1.24 grams in 100 ml of water would decrease the number of colonies of Propionibacterium acnes. The topical dose on intact human skin may be 1.7 grams (estimated).

The amount of PCA necessary for coating metal and or cloth is 20 to 30% PCA or 20-30 grams per 100 ml of 70% isopropyl alcohol. These compositions allow for higher concentrations, and also evaporate rapidly to dry state of PCA crystals on the metal or cloth.

When the antiviral composition of this invention are applied to a surface to be treated, the antiviral composition generally can include a concentration of the PCA, not including the carrier. Further, the PCA can be between 90%-97% by weight of the compound, and more preferably, between 95%-98% by weight of the compound. When the composition or compositions of this invention are applied to a surface to be treated they may be diluted for use as a sanitizer or as a preventive or prophylactically, and at greater concentrations for treatment.

In another aspect, the invention provides a method of inhibiting growth of a virus on a solid, smooth, porous or semi-porous, or cloth-like surface such as but not limited to a cloth, wound dressing, bandage, heart or vessel grafts, by treating the surface with a composition of the present invention, comprising PCA. The surface can be any solid, smooth, porous, or semi-porous, or cloth-like surface.

This disclosure also provides for a method comprising contacting a surface with an effective amount of the antimicrobial persister cell composition. By the term “effective amount” of a composition as provided herein is meant an amount of a composition sufficient to provide the desired benefit, either bactericidal or bacteriostatic, e.g., reduction or prevention of persister cell growth or survival. As disclosed herein, the exact amount required will vary from use to use depending on a variety of processing parameters, as understood by one of ordinary skill, such as the type of surface, the type of microorganism to be treated, the surface size, the mode of delivery, e.g., aerosol, spraying or dipping, and the like. Determination of what constitutes an “effective amount” is made by routine testing with known concentrations and adjusting those concentrations as needed to obtain the desired benefit and can be determined by one of ordinary skill in the art using routine experimentation.

When a composition of this invention is applied to a surface to be treated, the antimicrobial composition generally can include a concentration of PCA of at least 25 mM concentration, not including the carrier. Further, the PCA can be between 90%-97% by weight of the composition, and more preferably, between 95%-98% by weight of the composition.

When the antimicrobial composition or compositions of this invention are applied to a surface to be treated may be diluted for use as a sanitizer or as a preventive or prophylactically, and at greater concentrations for treatment.

In another aspect, the invention provides a method of inhibiting growth of persister cells in a biofilm on a solid, smooth, porous or semi-porous, or cloth-like surface (such as but not limited to a cloth, wound dressing, bandage, heart or vessel grafts) by treating the surface with a composition of the present invention comprising PCA. The surface can be any solid, smooth, porous or semi-porous, or cloth-like surface, including implants that are inserted into a patient.

The present invention thus provides a composition that destroys or inhibits growth of a biofilm. The composition is preferably PCA. The PCA may be mixed with 70% isopropyl alcohol. The concentration of PCA can be anywhere from about 20% PCA to 100% PCA. Preferably the concentration of PCA is about 20-50% by weight, or is about 20-40% by weight or is about 20-30% by weight or is 30% to 50% by weight. Additionally, the PCA is in the form of crystals that are embedded into a material such as a cloth or a mesh, such as titanium or stainless steel.

The present invention thus provides a composition that destroys or inhibits persister cells. The composition includes crystalline PCA. The PCA may be mixed with 70% isopropyl alcohol or ethanol. The concentration of PCA can be anywhere from about 20% PCA to 100% PCA. Preferably the concentration of PCA is about 20-50% by weight or is about 20-40% by weight or is about 20-30% by weight or is 30% to 50% by weight. Additionally, the PCA may be in the form of crystals that are embedded into a material such as a cloth or a mesh, such as titanium or stainless steel.

The invention provides another composition comprising about 17 to 40%, or 17 to 30% or 17 to 20% by weight of PCA, isopropyl alcohol or ethanol, propylene glycol and an essential oil, preferably of peppermint, or a citrus fruit (i.e. lemon, grapefruit, orange, lime, etc.). This composition is useful in the methods described in the invention, for example as a skin antiseptic as a surface disinfectant, as a spray to disinfect a surface, etc. The composition of the invention, may have at least PCA at 17+% by weight in at least 70-90% isopropyl alcohol, propylene glycol (15 mls in a 105 ml total solution) and an essential oil; i.e. peppermint or lemon etc.

The invention further provides a composition of PCA wherein the composition comprises or consists of PCA that can be applied directly or provided in various vehicles depending upon the application. A composition of 70% isopropyl or ethyl alcohol, propylene glycol and essential peppermint oil may be effective in use as a skin antiseptic. Higher concentration of 10% PCA (20 grams in 90 milliliters of 70% isopropyl alcohol) may be more effective than PCA in water. The following concentration may also be effective—the composition comprising or consisting of PCA (20 grams) 70% isopropyl alcohol (85 ML), propylene glycol (15 ml) and an essential oil (5 ml).

In addition to the components and administration of said compositions disclosed above, the compositions can be in the form of an aqueous solution and also deliver PCA in suspension and or upon drying produce a residual PCA coating. The compositions disclosed herein can also be in the form of a liquid, gel, suspension, dispersion, solid, emulsion, aerosol, for example, powders, tablets, capsules, pills, liquids, suspensions, dispersions or emulsions. Also, the compositions disclosed herein can be in the form suitable for dilutions. Similarly, the compositions can be in the form of a powder, cream, paste, gel or solid that can be reconstituted.

Other components can be present in the composition, if desired. For example, the composition can also include at least one additive selected independently from a carrier, a diluent, an adjuvant, a solubilizing agent, a suspending agent, a filler, a surfactant, an antimicrobial agent, a preservative, a viscosity modifier, a thixotropy modifier, a wetting agent, an emulsifier, or any combinations thereof. For example, the disclosed composition can further comprise at least one surfactant selected from a cationic surfactant, an anionic surfactant, a non-ionic surfactant, and an amphoteric surfactant. Additionally, the disclosed compositions may further comprise medicament selected from the group consisting of burn relief medications, anesthetic agents, wound cleansers, antiseptic agents, scar reducing agents, immunostimulating agents, anti-bacterial agents, biofilm destroying agents, antiviral agents, antikeratolytic agents, anti-inflammatory agents, antifungal agents, acne treating agents, sunscreen agents, dermatological agents, antihistamine agents, antibacterial agents, bioadhesive agents, inhibitors of prostaglandin synthesis, antioxidants, and mixtures thereof.

Also, the disclosed compositions can optionally include one or more additives such as carriers, adjuvants, solubilizing agents, suspending agents, diluents, surfactants, other antiviral or antimicrobial agents, preservatives, fillers, wetting agents, antifoaming agents, emulsifiers, and additives designed to affect the viscosity or ability of the composition to adhere to and/or penetrate a wound.

In one embodiment, the disclosed compositions including PCA are without causing significant undesirable biological effects or interacting in a deleterious manner with any of the other components of the composition in which it is contained.

In another embodiment, antiviral compositions of the present invention are formulated for use in liquids, solutions, gels, soaps, creams, powders, salves, and other preparations designed for topical use as antiseptic agents, sprays, foams, antibacterial treatments, wipes and the like. In another embodiment, antiseptic compositions of the present invention are formulated as a hand antiseptic, sanitizer or disinfectant.

In yet another embodiment, sanitizing compositions of the present invention are formulated for use in liquids, solutions, gels, soaps, and other preparations designed for use as sanitizing agents, liquids, including sprays, foams, gels, soaps, sanitizing treatments, and the like when used as a sanitizing solution, including but not limited to, use in food processing facilities, including food-processing equipment and utensils, and on other food-contact articles.

In yet another embodiment, sanitizing compositions of the present invention use in food processing facilities, including food-processing equipment and utensils, and on other food-contact articles are formulated to include any components generally recognized as safe for use in food processing facilities, including but not limited to, aqueous solutions containing potassium, sodium or calcium hypochlorite, a solution of hydrogen peroxide, an aqueous solution containing potassium iodide, sodium lauryl sulfate, sodium-toluenesulfonchloroamide, solutions containing dodecylbenzensulfonic acid, other acceptable detergents and the like.

In another aspect, the compositions of the present invention are used in food processing, packing, manufacturing, handling, preparing, treating, transporting, or holding as a food additive without causing undesirable effects or interacting in a deleterious manner. By way of example, protocatechuic acid can be used as an additive in meat, including the handling and processing, without causing undesirable effects or interacting in a deleterious manner with the meat.

In yet another aspect, the compositions of the present invention are used in food processing, including cold sterilization of food containers, including bottles, without causing undesirable effects or interacting in a deleterious manner.

In examples, the compositions disclosed herein can further comprise a carrier or vehicle. The term ‘carrier or vehicle’ means a compound, composition, substance, or structure that, when in combination with a compound or composition disclosed herein, facilitates preparation, administration, delivery, effectiveness, or any other feature of the compound or composition. Examples of carriers include water, isopropyl alcohol ethanol, polyols (propylene glycol, polyethylene glycol, glycerol, and the like), vegetable oils, and suitable mixtures thereof. “Pharmaceutically acceptable carrier” means a compound, composition, substance, or structure that is useful in neither preparing a pharmaceutical composition which is generally safe, non-toxic, and neither biologically nor otherwise undesirable and includes that which is acceptable for veterinary as well as human pharmaceutical use. In a further example, the compositions disclosed herein can also comprise adjuvants such as preserving, wetting, emulsifying, suspending agents, and dispensing agents.

Suitable suspending agents can include, for example, ethoxylated isostearyl alcohols, polyoxyethylene sorbitol and sorbitan esters, microcrystalline cellulose, aluminum metahydroxide, bentonite, agar-agar and tragacanth, or mixtures of these substances, and the like.

The disclosed compositions can also comprise solubilizing agents and emulsifiers, as for example, ethyl alcohol, isopropyl alcohol, ethyl carbonate, ethyl acetate, benzyl alcohol, benzyl alcohol, benzyl benzoate, propylene glycol, 1,3-butyleneglycol, dimethylformamide, oils, in particular, cottonseed oil, groundnut oil, corn germ oil, olive oil, castor oil and sesame oil, glycerol, tetrahydrofuran fury 1 alcohol, polyethylene glycols and fatty acid esters of sorbitan or mixtures of these substances, and the like. The additives can be present in the disclosed compositions in any amount with the PCA.

According to one aspect of this invention, there is provided an antimicrobial composition and a method of promoting wound healing by reducing microbial growth. A method of promoting healing of a wound in a mammal is provided, comprising administering PCA to the mammal in need of such treatment a therapeutically effective amount of the PCA compound wherein microbial growth is prevented or reduced and local growth hormone activity is optimized.

In a further embodiment, a method of promoting healing of a wound in a mammal is provided; comprising administering PCA to the mammal in need of such treatment a therapeutically effective amount of the PCA compound wherein microbial growth is reduced and local growth hormone activity is optimized.

In some embodiments, a method of promoting healing a wound further comprises applying a wound dressing or bandage that has been treated with a composition of PCA or 246 THBA or mixtures thereof.

In yet another aspect of the present invention, a method of treating persister cells in a patient in need thereof is provided, comprising administering PCA to the patient in need of treatment in an therapeutically effective amount of protocatechuic acid wherein growth of persister cells is reduced.

In another aspect of the present invention, a method of prophylactically treating a preoperative skin incision site is provided, comprising administering PCA to a patient in need of such treatment an effective amount of the PCA wherein persister cell growth is prevented or reduced.

In another aspect of the present invention, a method of disinfecting a surface comprising contacting said surface with PCA in an effective amount wherein microbial persister cell growth is prevented, reduced or eliminated.

In another aspect of the present invention, a method of disinfecting or sterilizing a surface is provided comprising contacting said surface with PCA in an effective amount wherein persister cell growth is prevented, reduced or eliminated and, further, where the microbial growth that is reduced may be an endogenous or exogenous source, including but not limited to P. acnes, S. aureus, P. aeruginosa, E. coli, S. epidermidis, S. pneumonia, Streptococcus species, C. difficile and Legionella.

In another aspect of the present invention, a method of post-operative treating a post-operative skin site is provided, comprising administering PCA to a post-operative skin site, such as a skin graft, skin graft donor site, a microdermabrasion site, or a surgical incision site, in an effective amount of PCA wherein persister cell growth is prevented, reduced or eliminated and local growth hormone production is optimized.

The supporting Examples were performed in a liquid environment, replicating the clinical environment. The reagent, protocatechuic acid (PCA) was applied to an article simulating the clinical condition of spraying the article with a dual purpose. The alcohol vehicle replicated the lethal effect on contact of an existing bacteria and/or virus on a hard surface. The residual PCA coating provided a lasting antibacterial/antiviral effect for subsequent exposure. A subsequent droplet containing virus engaged the PCA in an aqueous environment. There was an effect in 10 minutes on engaging the PCA crystal.

As used herein, the term virucidal generally means having the capacity to or tending to destroy or inactivate viruses.

As used herein, the term antibacterial generally means having the capacity to or tending to destroy or inactivate bacteria including persister cells.

The term facility generally refers to any public facility. Businesses, hospitals, gas stations, restaurants, public rest stops, including rest rooms, etc., airports, bus stations, stadiums and public entertainment facilities, public transportation stations and vehicles, movie theaters, health care facilities, medical offices, clinics, outpatient surgery centers, and any other business or facility where the public gathers and/or transits.

The term personal protective equipment includes face coverings and masks, gowns, aprons, gloves, shoes and shoe coverings, condoms, and rubber gloves, and any other article used for personal protection particularly used to protect from the transmission of viruses and bacteria.

The term ‘room’ generally means an enclosed space in a building particularly public facilities and buildings, hospitals, public transportation facilities, restaurants, entertainment facility, rest stops, or any other enclosed space where the public may gather.

A stabilizer may be a chemical that is used to prevent separation or degradation. Stabilizers can include emulsifiers and surfactants, for example, for stabilization of emulsions.

As used in the specification and claims, the singular forms “a,” “an,” and “the” include plural referents unless the context clearly dictates otherwise. Thus, for example, reference to “a composition” includes mixtures or combinations of two or more such compositions.

Throughout the specification and claims, the word “comprise” and variations of the word, such as “comprising” and “comprises,” means “including but not limited to,” and is not intended to exclude, for example, other components, extracts, additives, or steps. It is also contemplated that embodiments described as “comprising” components, the invention also includes those same inventions as embodiments “consisting of” or “consisting essentially of.”

Ranges can be expressed herein as “approximately” or from “about” one particular value, and/or to “about” another particular value. When such a range is expressed, another embodiment includes from the one particular value and/or to the other particular value.

A weight percent of a reagent, component, or compound unless specifically stated to the contrary, is based on the total weight of the reagent, component, composition or formulation in which the reagent, component, or compound is included, according to its usual definition.

By “reduce” or other forms of the word, such as “reducing” or “reduction,” is meant decrease or lower a characteristic (e.g., inflammation, growth, or viability of viruses).

By “promote” or other forms of the word, such as “promoting,” is meant to induce a particular event or characteristic, or delay the development or progression of a particular event or characteristic, or to minimize the chances that a particular event or characteristic will occur.

“Treat” or other forms of the word, such as “treating,” “treatment” or treated,” is used here to mean to administer a composition or to perform a method in order to induce, reduce, eliminate, and prevent a characteristic (e.g., inflammation, growth or viability of viruses). It is generally understood that treating involves providing an effective amount of the composition to the mammal or surface for treatment.

The term “vehicle” or “vehicle carrier” as used herein refers to mean the manner in which the reagents or compositions may be delivered, including as a liquid, salve, soap, foam, cream, solution, gel, spray, powder, wipes, antiviral treatments, wipes, and the like.

The term fog can generally mean a cloudlike mass or layer of minute droplets including crystals. The term fogging can mean to cover or envelop with a fog. Fogging can be accomplished with fogging or disinfecting machines well known in the art. For example, medical grade disinfecting fogging machines can preferably be used. Portable medical grade fogging machines are also preferred. Large scale industrial fogging machines can be used for large facilities like hospitals, stadiums, public entertainment facilities, etc.

A fog machine, fog generator, or smoke machine is generally a device that emits a dense vapor that appears similar to fog or smoke. An artificial fog may be used in large scale applications, and smaller, more affordable fog machines can be used for more localized applications. Fog machines typically used in a variety of industrial, training, health care, and military applications are contemplated. Typically, fog is created by vaporizing proprietary water and glycol-based or glycerin-based fluids (or through the atomization of mineral oil). This fluid (often referred to colloquially as fog juice) vaporizes or atomizes inside the fog machine. Upon exiting the fog machine and mixing with cooler outside air the vapor condenses, resulting in a thick visible fog.

Spraying is generally a fluid flying in small drops or particles for example mechanically created and blown and may be a jet of vapor or finely divided liquid and can be produced by a device (such as an atomizer or sprayer) by which the spray is created, dispersed, and/or applied.

By “additive” or “food additive” is meant to the use as a component of any food (including any substance intended to use in producing manufacturing, packing, processing, preparing, treating, packaging, transporting, or holding food).

By “antiseptic” is meant an antimicrobial reagent or composition that is applied to any surface, including skin or tissue, to effect (e.g., eliminate, inhibit, decrease or prevent) viral, bacterial, and/or persister cell growth, viability, and/or survival.

By “disinfect” or other forms of the word, such as “disinfectant” or “disinfecting,” is meant decrease or lower a characteristic (e.g., eliminate, reduce, inhibit, decrease, or prevent) viral, bacterial and/or persister cell growth, viability or survival at any concentration. It is generally understood that disinfecting involves providing an effective amount of the composition to any surface, but particularly solid surfaces, whether smooth or porous or semi-porous, or cloth-like surfaces.

By “sanitize” or other forms of the word, such as “sanitizer” or “sanitizing,” is meant decrease or lower a characteristic (e.g., eliminate, reduce, inhibit, decrease, or prevent) viral, bacterial, and/or persister cell growth, viability or survival at any concentration. It is generally understood that sanitizing involves providing an effective amount of the composition to any surface. Further, it is generally understood that sanitizing solutions and sanitizing components are those solutions that may be safely used on food-processing equipment and utensils and on other food-contacting conditions.

By “sterilize” it is meant to kill on the article being sterilized. Sterilize and sterilization include cold sterilization methods.

By “isolated” or “an isolate” as it refers to either the compounds or reagents described herein means not 100% by weight but rather approximately 95% to 97% of the compound or reagent by weight.

The term “medicament” as used herein refers to any wound treatment, including but not limited to the group consisting of burn relief medications, anesthetic agents, wound cleansers, antiseptic agents, scar reducing agents, immunostimulating agents, antiviral agents, antikeratolytic agents, anti-inflammatory agents, antifungal agents, acne treating agents, sunscreen agents, dermatological agents, antihistamine agents, antibacterial agents, bioadhesive agents, inhibitors of prostaglandin synthesis, antioxidants, and mixtures thereof.

An implant is generally a medical device manufactured to replace a missing biological structure, support a damaged biological structure, or enhance an existing biological structure. See e.g., Implant (medicine), Wikipedia, the free encyclopedia, last edited 3 Sep. 2021, herein incorporated by reference.

Microbial persister cells as used herein are cells that resist treatment and become antimicrobial tolerant by changing to a state of dormancy. See Persister cells, Wikipedia, the free encyclopedia, last edited 17 May 2021, herein incorporated by reference.

Unless stated to the contrary, a formula contemplates each possible isomer.

The term “nutraceutical” as used herein refers to any food stuff, including a dietary supplement or fortified food, provided for potential health and medical benefits.

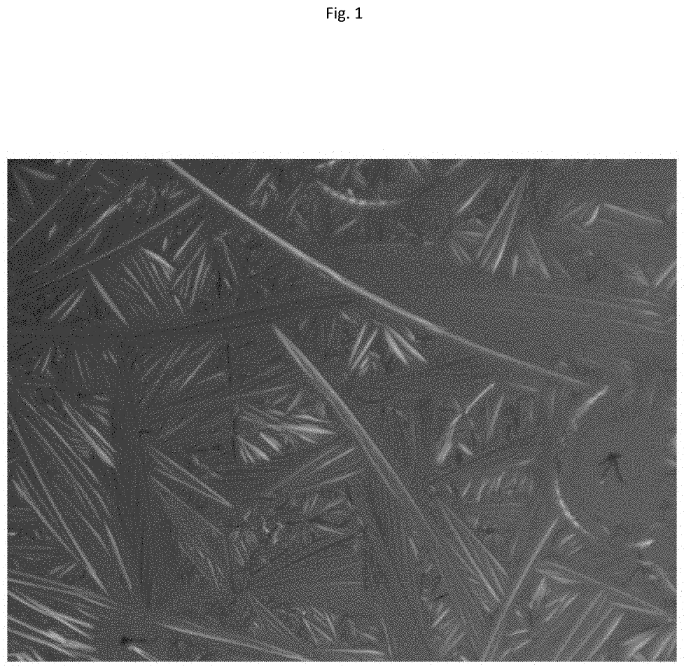

FIG. 1 shows crystals of PCA upon drying on a surface.

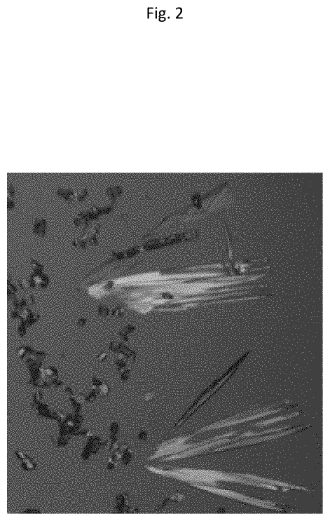

FIG. 2 shows a photomicrograph of crystals of PCA in a water droplet under high power magnification. This figure also shows small prism crystals not yet converted to needles as this was just 30 minutes after visually dissolved in distilled water.

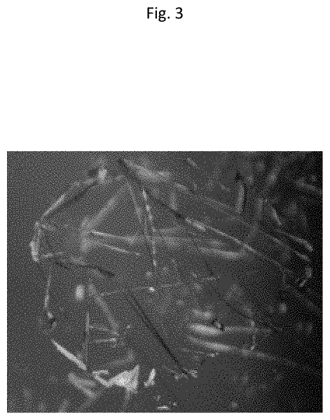

FIG. 3 shows a photomicrograph of crystals of PCA dissolved in ethanol in 30 minutes. The high-power magnification shows multiple needle shaped crystals.

### Example 1

In one example PCA was deposited on the skin. It was staged at a higher concentration for illustrative purposes. The PCA forms a layer and protective barrier on the skin.

### Example 2

In a second example, PCA crystals were applied to a metallic surface one month prior. A 2×0.5 mm bare area in the middle could not be wiped off, and the crystals were scraped off with a fingernail and some resistance. A pile up of crystals occurred on a right end of the scrape.

### Example 3

In a third example a steel utensil was used in stirring a 30% concentration of PCA in ethanol. A PCA coating formed which was visible, uniform and quickly applied.

### Example 4

Example 4 demonstrates the results of laboratory studies utilizing a methodology replicating the clinical therapeutic environment whereby PCA crystals engage the SARS CoV-2 virus in an aqueous environment. These studies demonstrate the effectiveness of Protocatechuic Acid (PCA) crystals against SARS-CoV-2, the causative virus for COVID19, as well as other bacteria and germs including microbial persister cells. The mechanism of action would be the same for a virus and microbial persister cells, i.e., protocatechuic acid crystals physically disrupting and destroying the virus or microbial persister cells. In addition, this mechanism would be successful for any encapsulated virus or bacteria or microbial persister cell.

The Test Article (TA) used for this study was Protocatechuic Acid (PCA). The TA was received as an off-white powder. The PCA solution was prepared to be 30% PCA w/v in Ethanol. The PCA was prepared in 5 g increments to pre-warmed 50-60 mL ethanol until dissolved for a total of 30 g PCA in the solution. Additional ethanol was then added volumetrically to be equivalent to 100 mL.

The Test Substrates (TS) were a Plastic-type material sourced from a clear plastic laboratory bottle (Corning 431731 Octagonal bottle, 150 mL), cloth (the top layer of a N95 mask [3M 8210]), and a Sponsor-provided wire mesh to serve as a substrate for the TA. All test substrates were cut to approximately 1″×1″ in size. The test substrates were submerged into the PCA solution and dried horizontally to allow for even coating. After the substrate was thoroughly dried, the test substrate was re-submerged into the PCA solution for an additional coating.

The Test Virus used for this study was 2019 Novel Coronavirus, Isolate USA-WA1/2020 (SARS-CoV-2). The virus was stored at approximately −65° C. prior to use. The multiplicity of infection (MOI) was 0.01 TCID₅₀/cell.

The Cell Culture used for the TCID₅₀ test was African Green Monkey Kidney Cells (Vero E6 cells) that were maintained in Dulbecco's Minimum Essential Medium with 10% fetal calf serum (DMEM-2). All growth media contained heat-inactivated fetal calf serum and antibiotics.

The test design is shown below in Table 1. This test assesses the TA on a substrate in various conditions as shown in Table 1.

The Test Substrate was coated with PCA as described above. The test substrates was treated with PCA twice and allowed to fully dry overnight. In general, the time from the first coat to the next day's virus exposure was approximately 24 hours.

The treated Test Substrate plus TA was placed into a sterile 6 well cell culture plate and approximately 100 μL total of a ≥1×10⁶ TCID₅₀/mL SARS-CoV-2 virus was such that 50 μL of virus was layered on each sides of the treated test substrates. This was the procedure used for the initial Day 1 experiment.

For the confirmatory test, in an attempt to increase the recorded titer of the controls, the treated Test Substrate plus TA was placed into a sterile 6 well cell culture plate and the same amount of virus was layered onto both sides of the test substrate. However, an addition 50 μL of DMEM was added to each side to reduce the inactivation of the virus due to desiccation. Additionally, a glass coverslip was also added to help mitigate against evaporation.

After application of the virus, the virus was contact with the Test substrates for approximately 10 minutes (Groups 1, 2, and 3, Control groups 7, 8, and 9), 60 minutes (Groups 4, 5, and 6, Control Groups 10, 11, and 12). Each substrate per time per test article was performed in duplicate.

A cell culture-only control was included to indicate that cells without any TA or virus remain healthy throughout the assay. Virus-only controls without substrate was added for each timepoint to verify that the assay was performing as expected.

After the incubation time, the treated substrate was washed with 1 mL of cell culture media (DMEM-2) for approximately 5-10 minutes within the 6 well cell culture plate and the glass cover slip removed if necessary. This was the equivalent to a 10-fold dilution. The plate was gently stirred via an orbital shaker to enhance the recovery of the virus.

For the TCID₅₀, the cell culture media (DMEM-2) used to wash the Test Substrate was serially diluted 10 fold and transferred into respective wells of a 96-well plate which contained a monolayer of African Green Monkey Kidney Cells (Vero E6 cells) for titration. The TCID₅₀ assay was performed non-GLP according to IITRI Standard Operating Procedures for the assay. The TCID₅₀ titers was calculated using the method of Reed-Meunch.

TABLE 1
Study Design

| Group | Test and Control Groups | PCA |
|---|---|---|
| 1 | Plastic (10 minute exposure) | 2 replicates |
| 2 | Cloth (10 minute exposure) | 2 replicates |
| 3 | Mesh (10 minute exposure) | 2 replicates |
| 4 | Plastic (60 minute exposure) | 2 replicates |
| 5 | Cloth (60 minute exposure) | 2 replicates |
| 6 | Mesh (60 minute exposure) | 2 replicates |
| 7 | Virus Control-Plastic (10 minute exposure) | 2 replicates |
| 8 | Virus Control-Cloth (10 minute exposure) | 2 replicates |
| 9 | Virus Control-Mesh (10 minute exposure) | 2 replicates |
| 10 | Virus Control-Plastic (60 minute exposure) | 2 replicates |
| 11 | Virus Control Cloth (60 minute exposure) | 2 replicates |
| 12 | Virus Control Mesh (60 minute exposure) | 2 replicates |

The Test Articles, Test Substrates and virus (SARS-CoV-2) were prepared according to protocol and each preparation was noted in the study notebook for this study.

Two experimental days were run for this study with the second day as run as a confirmatory. For Day 1, after coating the Test Substrates with PCA as described above (Groups shown in Table 1 above), a TCID₅₀ was performed at 10 minutes or 60 minutes after initial application of the virus. There was an observed log difference between the experimental groups (Group 1: Plastic-10 min, Group 2: Cloth-10 min, Group 3: Mesh-10 min, Group 7: Plastic-60 min, Group 8: Cloth-60 min, Group 9: Mesh-60 min) when compared to the controls (Group 4: Plastic-10 min, Group 5: Cloth-10 min, Group 6: Mesh-10 min, Group 10: Plastic-60 min, Group 11: Cloth-60 min, Group 12: Mesh-60 min)

Day 1 results observed did indicate some log reductions in infectious virus titers under the experimental conditions performed for this study when compared to controls. The results are shown below in Table 2.

TABLE 2
Initial Experimental Run Results.

| | Test | | Incubation | TCID₅₀ | Log | | log |
|---|---|---|---|---|---|---|---|
| Group | Article/substrate | Replicate | time | Log₁₀/mL* | average | St. Dev. | difference^{∧} |
| 1 | PCA/plastic | 1 | 10 Min | 3.75 | 3.75 | 0.00 | −0.63 |
| | PCA/plastic | 2 | 10 min | 3.75 | | | |
| 2 | PCA/Cloth | 1 | 10 min | 2.75 | 2.75 | 0.00 | −1.25 |
| | PCA/Cloth | 2 | 10 min | 2.75 | | | |
| 3 | PCA/Mesh | 1 | 10 min | 3.50 | 3.38 | 0.18 | −0.25 |
| | PCA/Mesh | 2 | 10 min | 3.25 | | | |
| 4 | Control/plastic | 1 | 10 Min | 3.75 | 4.38 | 0.88 | N/A |
| | Control/plastic | 2 | 10 min | 5.00 | | | |
| 5 | Control/Cloth | 1 | 10 min | 3.75 | 4.00 | 0.35 | N/A |
| | Control/Cloth | 2 | 10 min | 4.25 | | | |
| 6 | Control/Mesh | 1 | 10 min | 3.75 | 3.63 | 0.18 | N/A |
| | Control/Mesh | 2 | 10 min | 3.50 | | | |
| 7 | PCA/plastic | 1 | 60 Min | 3.25 | 2.88 | 0.53 | −1.13 |
| | PCA/plastic | 2 | 60 Min | 2.50 | | | |
| 8 | PCA/Cloth | 1 | 60 Min | 2.50 | 2.75 | 0.35 | −1.00 |
| | PCA/Cloth | 2 | 60 Min | 3.00 | | | |
| 9 | PCA/Mesh | 1 | 60 Min | 1.00 | 1.50 | 0.71 | −2.00 |
| | PCA/Mesh | 2 | 60 Min | 2.00 | | | |
| 10 | Control/plastic | 1 | 60 Min | 3.75 | 4.00 | 0.35 | N/A |
| | Control/plastic | 2 | 60 Min | 4.25 | | | |
| 11 | Control/Cloth | 1 | 60 Min | 4.00 | 3.75 | 0.35 | N/A |
| | Control/Cloth | 2 | 60 Min | 3.50 | | | |
| 12 | Control/Mesh | 1 | 60 Min | 3.25 | 3.50 | 0.35 | N/A |
| | Control/Mesh | 2 | 60 Min | 3.75 | | | |
| 13 | Virus control | N/A | 10 min | 5.75 | N/A | N/A | N/A |
| | (no coupon) | | | | | | |
| 14 | Virus control | N/A | 60 min | 5.75 | N/A | N/A | N/A |
| | (no coupon) | | | | | | |

*limit of detection is 1.5 TCID₅₀ Log₁₀/mL
^{∧}Log difference is defined as the averaged TCID₅₀ Log₁₀/mL from virus control on substrates - TCID₅₀ Log₁₀/mL from replicate test group. Log difference indicates amount of reduction in infectious virus when comparing the virus control on substrate to the test group.

For Day 2, after coating the Test Substrates with PCA as described above (Groups shown in Table 1 above), a TCID₅₀ was performed at 10 minutes or 60 minutes after initial application of the virus. There was a modification to the procedures to see if the viral titers could be increased. To mitigate against evaporation during the incubation periods, these modifications included adding an additional 50 μl of DMEM on each side of the test substrate and a glass coverslip was placed on top of the test substrate. As with the Day 1 run, there was an observed log difference between the experimental groups (Group 1: Plastic-10 min, Group 2: Cloth-10 min, Group 3: Mesh-10 min, Group 7: Plastic-60 min, Group 8: Cloth-60 min, Group 9: Mesh-60 min) when compared to the controls (Group 4: Plastic-10 min, Group 5: Cloth-10 min, Group 6: Mesh-10 min, Group 10: Plastic-60 min, Group 11: Cloth-60 min, Group 12: Mesh-60 min) as shown in Table 3, thereby confirming the results from the Day 1 run.

TABLE 3
Confirmatory Experimental Run Results.

| | Test | | Incubation | TCID₅₀ | Log | | log |
|---|---|---|---|---|---|---|---|
| Group | Article/substrate | Replicate | time | Log₁₀/mL* | average | St. Dev. | difference^{∧} |
| 1 | PCA/plastic | 1 | 10 Min | 4.25 | 4.38 | 0.18 | −1.13 |
| | PCA/plastic | 2 | 10 min | 4.50 | | | |
| 2 | PCA/Cloth | 1 | 10 min | 4.25 | 4.25 | 0.00 | −1.13 |
| | PCA/Cloth | 2 | 10 min | 4.25 | | | |
| 3 | RCA/Mesh | 1 | 10 min | 4.75 | 4.63 | 0.18 | −1.13 |
| | RCA/Mesh | 2 | 10 min | 4.50 | | | |
| 4 | Control/plastic | 1 | 10 Min | 5.50 | 5.50 | 0.00 | N/A |
| | Control/plastic | 2 | 10 min | 5.50 | | | |
| 5 | Control/Cloth | 1 | 10 min | 5.50 | 5.38 | 0.18 | N/A |
| | Control/Cloth | 2 | 10 min | 5.25 | | | |
| 6 | Control/Mesh | 1 | 10 min | 5.75 | 5.75 | 0.00 | N/A |
| | Control/Mesh | 2 | 10 min | 5.75 | | | |
| 7 | PCA/plastic | 1 | 60 Min | 3.50 | 3.63 | 0.18 | −1.50 |
| | PCA/plastic | 2 | 60 Min | 3.75 | | | |
| 8 | PCA/Cloth | 1 | 60 Min | 2.00 | 2.75 | 1.06 | −2.38 |
| | PCA/Cloth | 2 | 60 Min | 3.50 | | | |
| 9 | PCA/Mesh | 1 | 60 Min | 4.50 | 4.38 | 0.18 | −0.88 |
| | PCA/Mesh | 2 | 60 Min | 4.25 | | | |
| 10 | Control/plastic | 1 | 60 Min | 5.00 | 5.13 | 0.18 | N/A |
| | Control/plastic | 2 | 60 Min | 5.25 | | | |
| 11 | Control/Cloth | 1 | 60 Min | 4.50 | 5.13 | 0.88 | N/A |
| | Control/Cloth | 2 | 60 Min | 5.75 | | | |
| 12 | Control/Mesh | 1 | 60 Min | 5.25 | 5.25 | 0.00 | N/A |
| | Control/Mesh | 2 | 60 Min | 5.25 | | | |
| 13 | Virus control (no | N/A | 10 min | 5.75 | N/A | N/A | N/A |
| | coupon) | | | | | | |
| 14 | Virus control (no | N/A | 60 min | 5.75 | N/A | N/A | N/A |
| | coupon) | | | | | | |

*limit of detection is 1.5 TCID₅₀ Log₁₀/mL
^{∧}Log difference is defined as the averaged TCID₅₀ Log₁₀/mL from virus control on substrates - TCID₅₀ Log₁₀/mL from replicate test group. Log difference indicates amount of reduction in infectious virus when comparing the virus control on substrate to the test group.

TABLE 4
Comparison between Initial Experimental Run to Confirmatory Run

| Test Article/ | Incubation | Day 1: | Confirmatory: |
|---|---|---|---|
| substrate | time | Log difference | Log difference |
| PCA/plastic | 10 Min | −0.63 | −1.13 |
| PCA/Cloth | 10 min | −1.25 | −1.13 |
| PCA/Mesh | 10 min | −0.25 | −1.13 |
| PCA/plastic | 60 Min | −1.13 | −1.50 |
| PCA/Cloth | 60 min | −1.00 | −2.38 |
| PCA/Mesh | 60 min | −2.00 | −0.88 |

A PCA coating on the three test substrates, appeared to show some effectiveness in reducing infectious virus titers in the experimental condition shown in the protocol after the 10 minutes and 60 minutes post-exposure incubation when compared to the virus control on substrate. From both the Day 1 and the confirmatory runs, the log reduction varied between a 0.63 to a 2.38 log reduction.

Overall, these results show that PCA when coated approximately 24 hours prior to virus exposure can reduce infectious virus performance on a substrate, however, overall effectiveness was somewhat varied between runs and test substrate. Additionally, it appears that a longer incubation time may be marginally more effective than the shorter 10 minute time. A 1 to 2 log reduction/difference corresponds to a 90 to 99% inactivation while a 3 log reduction corresponds to a 99.9% inactivation.

### Example 4

The second laboratory utilized test coupons made of solid stainless steel, plastic and K95 mask were coated in 30% w/v PCA in 70% ethanol. Each coupon was dipped in PCA, allowed to dry, dipped again and allowed to dry with the opposite side of the coupon facing up. Once dry, 200 ul virus was added to each coupon and allowed to dry (45 minutes-1 h drying time). Virus was recovered by adding 2 ml DMEM/F12 media and washing the coupon, without scraping so as not to dislodge PCA crystals. A yellow color change in the media was observed indicating acidification of the media upon addition to the PA-coated coupon. The recovered virus was added to empty 96 well plates and diluted 1:10 down the plate. This was then added to Vero E6 cells that had grown to ˜70% confluence. Cytotoxicity controls without virus and recovery controls without PCA were also done in the same manner. After addition to the cells, plates were read at day 4 for the presence of cytopathic effect (CPE) due to viral infection of cells. Note that cytotoxicity and CPE cannot be differentiated in this assay, thus any dead cells are marked as positive.

Cytotoxicity was seen up to 1:100 dilution for the K95, and 1:10 for the stainless steel and plastic coupons. Positive CPE for virus recovery controls was seen at least down to 1:10,000 dilutions for all 3 coupon materials, thus each coupon material was adequate for coupon testing. Results are shown in the table below. The SS=stainless steel, K95=K95 mask and P=plastic. +PCA means coupons coated with PCA. No PCA (e.g., SS-1) indicates virus recovery controls with no PCA coating that had virus dried and recovered.

TABLE 5

| | | | | | | | Log | |
|---|---|---|---|---|---|---|---|---|
| | | | | | | Average | Reduction | Percent |
| | Replicate | | | Log10 | Average | Log10 | to Virus | Log |
| Sample Name | # | TCID50 | TCID50/mL | TCID50 | TCID50 | TCID50 | Controls | Reduction |
| SS + PCA-1 | 1 | 501.1872 | 0.01995262 | 2.70 | 298.9493 | 2.37 | 2.93 | 99.88% |
| SS + PCA-2 | 2 | 79.43282 | 0.12589254 | 1.90 | | | | |
| SS + PCA-3 | 3 | 316.2278 | 0.03162278 | 2.50 | | | | |
| SS-1 | 1 | 87992.25 | 0.00011365 | 4.94 | 226075.8 | 5.29 | | |
| SS-2 | 2 | 316227.8 | 3.1623E−05 | 5.50 | | | | |
| SS-3 | 3 | 274007.4 | 3.6495E−05 | 5.44 | | | | |
| K95 + PCA-1 | 1 | 316.2278 | 0.03162278 | 2.50 | 182.4589 | 2.10 | 2.45 | 99.65% |
| K95 + PCA-2 | 2 | 199.5262 | 0.05011872 | 2.30 | | | | |
| K95 + PCA-3 | 3 | 31.62278 | 0.31622777 | 1.50 | | | | |
| K95-1 | 1 | 58230.63 | 0.00017173 | 4.77 | 39285.11 | 4.55 | | |
| K95-2 | 2 | 19952.62 | 0.00050119 | 4.30 | | | | |
| K95-3 | 3 | 39672.07 | 0.00025207 | 4.60 | | | | |
| P + PCA-1 | 1 | 50.11872 | 0.19952623 | 1.70 | 88.00117 | 1.91 | 3.94 | 99.99% |
| P + PCA-2 | 2 | 125.8925 | 0.07943282 | 2.10 | | | | |
| P + PCA-3 | 3 | 87.99225 | 0.11364637 | 1.94 | | | | |
| P-1 | 1 | 1217075 | 8.2164E−06 | 6.09 | 971841.2 | 5.86 | | |
| P-2 | 2 | 203950 | 4.9032E−05 | 5.31 | | | | |
| P-3 | 3 | 1494498 | 6.6912E−06 | 6.17 | | | | |

While this disclosure includes specific examples, it will be apparent after an understanding of the disclosure of this application has been attained that various changes in form and details may be made in these examples without departing from the spirit and scope of the claims and their equivalents.

1. A method for destroying, inactivating, and/or inhibiting a microbial persister cell comprising: contacting the persister cell with a composition comprising protocatechuic acid crystals.

2. The method of claim 1, wherein the composition further comprises a liquid vehicle and a stabilizer.

3. The method of claim 1, wherein the stabilizer is an essential oil.

4. The method of claim 1, wherein the liquid vehicle comprises an alcohol, water, and/or propylene glycol.

5. The method of claim 1, wherein the alcohol has a boiling point between about 50° C. and about 100° C.

6. The method of claim 6, wherein the alcohol comprises ethanol or isopropyl alcohol.

7. The method of claim 1, wherein the persister cells are derived from Staphylococcus spp., S. aureus, S. epidermidis, and V. capitis; Pseudomonas spp., P. aeruginosa, Burkholderia spp. B. cepacian, B. pseudomallei; Salmonella serovars, Salmonella typhi; Vibrio spp. V. cholerae; Shigella spp., Brucella spp. B. melitensis; Escherichia spp. E. coli; Lactobacillus spp. L. acidophilus; Serratia spp. S. marcescens; Neisseria spp. such as N. gonorrhoeae, Candida albicans and/or Candida auris.

8. The method of claim 1, wherein the method comprises spraying, wiping, coating, fogging, and/or infusing a subject's skin or personal protective equipment, implant, room and/or facility, with the composition, and the composition leaves a crystalline protocatechuic acid residue or coating on the subject's skin or personal protective equipment, implant, room and/or facility.

9. The method of claim 8, wherein the article of personal protective equipment comprises a face covering, a gown, a glove, a rubber glove, a condom, a coat, pants, a shoe, a head covering, and/or a shirt.

10. The method of claim 8, wherein the room and/or facility comprises a hard-outer surface and the composition is sprayed or coated thereon.

11. The method of claim 8, wherein the facility comprises a health care facility, walls, floors, lights, operating table, hospital benches, hospital equipment, patient beds, and/or surgical instruments.

12. The method of claim 8, wherein the facility comprises a gas pump handle, a credit card, a credit card terminal, a door, a doorknob, a table, a countertop, a handrail, and/or a button.
